(19) United States
(12) Patent Application Publication
(10) Pub. No.: US 2025/0326686 A1
(43) Pub. Date: Oct. 23, 2025

(54) TRANSPARENT SUBSTRATE PROVIDED WITH A FUNCTIONAL STACK OF THIN LAYERS

(71) Applicant: SAINT-GOBAIN GLASS FRANCE, COURBEVOIE (FR)

(72) Inventors: Denis GUIMARD, AUBERVILLIERS (FR); Cécile DELBECQ, AUBERVILLIERS (FR); Anne LELARGE, AUBERVILLIERS (FR); Romain HIVET, AUBERVILLIERS (FR)

(21) Appl. No.: 18/721,530

(22) PCT Filed: Dec. 16, 2022
(86) PCT No.: PCT/EP2022/086262

§ 371 Date: Dec. 18, 2024

(30) Foreign Application Priority Data
Dec. 22, 2021 (FR) FR2114274

(51) Int. Cl. C03C 17/36

(52) U.S. Cl. CPC C03C 17/366; C03C 17/3649; C03C 2217/219; C03C 2217/24; C03C 2217/256; C03C 2217/26; C03C 2218/156

(57) ABSTRACT

A transparent substrate provided with a functional stack of thin layers on at least one of its faces, the functional stack including, starting from the substrate, at least one metallic functional layer placed between two dielectric modules of thin layers, and wherein at least one of the dielectric modules of thin layers includes a layer of tungsten oxide, and the tungsten oxide includes at least one doping element selected from the chemical elements of group 1 according to the IUPAC nomenclature.

### TECHNICAL FIELD

The invention relates to a transparent substrate provided with a functional stack of thin layers.

### TECHNICAL BACKGROUND

Functional stacks of thin layers are commonly used to provide functions of thermal insulation and/or solar protection to glazings. These glazings can equip buildings or vehicles. They aim in particular to reduce the air-conditioning effort and/or to reduce excessive overheating (so-called “solar control” glazings) and/or to reduce the amount of energy dissipated to the outside (so-called “low-emission” glazings).

One type of functional stack of thin layers used in particular comprises a metallic functional layer, in particular based on silver, allowing the reflection of a part of the electromagnetic radiation, in particular infrared radiation.

The metallic functional layer is generally arranged between two dielectric assemblies, also called dielectric modules, in order to neutralize the optical effects of reflection and refraction in the visible range. These dielectric modules may comprise one or more thin dielectric layers of the nitride type, for example silicon or aluminum nitride, and/or of the oxide type, for example silicon, zinc, or tin oxide.

Solar control functions are desired for the glazings capable of being exposed to high sunshine levels. The capacity of a glazing to limit the amount of light energy transmitted is defined by the solar factor, g, which is the ratio of the total energy transmitted through the glazed surface or the interior glazing to the incident solar energy. The lower the solar factor, g value, the better the protection against solar radiation.

JP H0812378 A [NISSAN MOTOR] Jan. 16, 1996 describes a functional “solar control” stack comprising a tungsten oxide layer arranged between two dielectric layers. The stack makes it possible to reduce the surface electrical resistance and to increase the transparency to radio waves relative to the stacks comprising a metallic functional layer, in particular based on silver.

JP 2010180449 A [SUMITOMO METAL MINING CO [JP]] Aug. 19, 2010 describes a layer based on tungsten oxide deposited by sputtering using a tungsten oxide target comprising chemical elements selected from hydrogen, alkali metals, alkaline earth metals and rare earth metals. The layer has a “solar control” function by virtue of its high absorption of near-infrared radiation.

EP 3686312 A1 [SUMITOMO METAL MINING CO [JP]] Jul. 29, 2020 describes a layer based on cesium oxide doped with cesium, and a method for depositing such a layer by sputtering. The layer has a transparency to radio waves and a “solar control” function by virtue, in particular, of its high absorption of infrared radiation.

### SUMMARY OF THE INVENTION

### Technical Problem

For certain applications, for example in building and construction markets, it is desirable for the functional stack to have a high light transmission, TL, in the visible range, in particular greater than 67% or even 77%, in order to ensure sufficient natural illumination and comfort of the interior and to reduce the use of domestic artificial lighting.

A functional stack is called a functional stack suitable for such applications when it meets a triple requirement: a high light transmission, a low solar factor value and a low emissivity value. A functional stack is therefore suitable when it has a selectivity value, s, defined as the ratio of the light transmission to the high solar factor and a low emissivity.

The prior art solutions consisting of using, in the functional stack, only infrared radiation absorbent layers as functional layers, are not suitable because they have a higher emissivity, incompatible for example with applications on the residential market.

There is therefore a need for a functional stack suitable for “solar control” applications in a residential market, that is, having a high selectivity and suitable overall energy performance levels, in particular regarding the emissivity.

### Solution to the Technical Problem

According to a first aspect of the invention, a transparent substrate is provided having a functional stack of thin layers as described in claim 1, the dependent claims being advantageous embodiments.

According to a second aspect of the invention, a glazing is provided comprising a transparent substrate according to the first aspect of the invention.

According to a third aspect of the invention, a method is provided for manufacturing a transparent substrate according to the first aspect of the invention.

### Advantages of the Invention

A first advantage of the invention is that it provides a suitable “solar control” functional stack, in particular for applications in building and construction markets. The functional stack satisfies the triple requirement of a high light transmission, a low solar factor value, and a low emissivity. It has a high selectivity and suitable overall energy performance levels.

As examples, a transparent substrate provided with a functional stack in accordance with the first aspect of the invention may, compared to a conventional functional stack, have a solar factor value lower than at least 2%, or even at least 4%, and an equivalent light transmission, or even greater than at least 1%, or even at least 2%.

A second advantage is that the tungsten oxide layer has no influence, at least very little, on the color of the stack relative to a conventional functional stack. The color specifications are thus always respected when such a layer is inserted into an existing functional stack.

Another advantage of the invention is that the tungsten oxide layer can be deposited by a magnetron sputtering method, in particular using a tungsten oxide target. Since the functional stacks of thin layers are generally deposited by a magnetron sputtering method, the existing methods can be more readily adapted.

### BRIEF DESCRIPTION OF THE DRAWINGS

FIG. 1 is a schematic depiction of a first embodiment of the first aspect of the invention.

FIG. 2 is a schematic depiction of a second embodiment of the first aspect of the invention.

FIG. 3 is a depiction of the evolution of the optical extinction coefficient of several examples of cesium-doped tungsten oxide layer as a function of wavelength.

FIG. 4 is a depiction of the evolution of the optical refractive index of several examples of cesium-doped tungsten oxide layer as a function of wavelength.

FIG. 5 is a schematic depiction of a third embodiment of the first aspect of the invention.

FIG. 6 is a schematic depiction of a fourth embodiment of the first aspect of the invention.

FIG. 7 is a schematic depiction of a fifth embodiment of the first aspect of the invention.

FIG. 8 is a schematic depiction of a sixth embodiment of the first aspect of the invention.

FIG. 9 is a schematic depiction of a first embodiment of a glazing according to the second aspect of the invention.

FIG. 10 is a schematic depiction of a second embodiment of a glazing according to the second aspect of the invention.

FIG. 11 is a schematic depiction of the light transmission and of the solar factor for seventeen examples of glazing according to the invention and four counter-examples.

FIG. 12 is a schematic depiction of the light reflection on the interior face and the exterior face for seventeen examples of glazing according to the invention and four counter-examples.

FIG. 13 is a schematic depiction of the color parameters a* and b* in transmission, in internal reflection and in external reflection for seventeen examples of glazing according to the invention and four counter-examples.

### DETAILED DESCRIPTION OF EMBODIMENTS

The following definitions and conventions are used.

The term “above”, respectively “below”, describing the position of a layer or of an assembly of layers and defined in relation to the position of another layer or another assembly, means that said layer or said assembly of layers is closer to, respectively further from, the substrate. These two terms, “above” and “below”, do not at all mean that the layer or the assembly of layers which they describe and the other layer or the other assembly with respect to which they are defined are in contact. They do not exclude the presence of other intermediate layers between these two layers. The expression “in contact” is explicitly used to indicate that no other layer is positioned between them.

Without any fuller information or qualifier, the term “thickness” used for a layer corresponds to the physical, real or geometric thickness, e, of said layer. It is expressed in nanometers.

The expression “dielectric module” denotes one or more layers in contact with one another forming an assembly of layers which is dielectric overall, that is to say that it does not have the functions of a functional metal layer. If the dielectric module comprises several layers, they may themselves be dielectric. The physical, real or geometric thickness, of a dielectric module of layers, corresponds to the sum of the physical, real or geometric thicknesses, of each of the layers which constitute it.

In the present description, the expressions “a layer of” or “a layer based on”, used to describe a material or a layer as to what it contains, are used equivalently. They mean that the mass fraction of the constituent that it comprises is at least 50%, in particular at least 70%, preferably at least 90%. In particular, the presence of minority or doping elements is not excluded.

The term “transparent” used to describe a substrate means that the substrate is preferably colorless, non-opaque and non-translucent in order to minimize the absorption of the light and thus retain a maximum light transmission in the visible electromagnetic spectrum.

“Light transmittance” is understood to mean the light transmittance, denoted TL, as defined and measured in section 4.2 of the standard EN 410.

The light transmission in the visible spectrum, TL, the solar factor, g, and the selectivity, s, the internal reflection, Rint, and the external reflection, Rext, in the visible spectrum are defined, measured and calculated in conformity with the standards EN 410, ISO 9050 and ISO 10292.

In accordance with the nomenclature of IUPAC, group 1 of the chemical elements comprises hydrogen and alkaline elements, that is, lithium, sodium, potassium, rubidium, cesium and francium.

The expressions “optical refraction index” and “optical extinction coefficient”, are understood as the optical refraction index, n, and optical extinction coefficient, k, as defined in the technical field, in particular according to the Forouhi & Bloomer described in the Forouhi & Bloomer, Handbook of Optical Constants of Solids II, Palik, E. D. (ed.), Academic Press, 1991, Chapter 7.

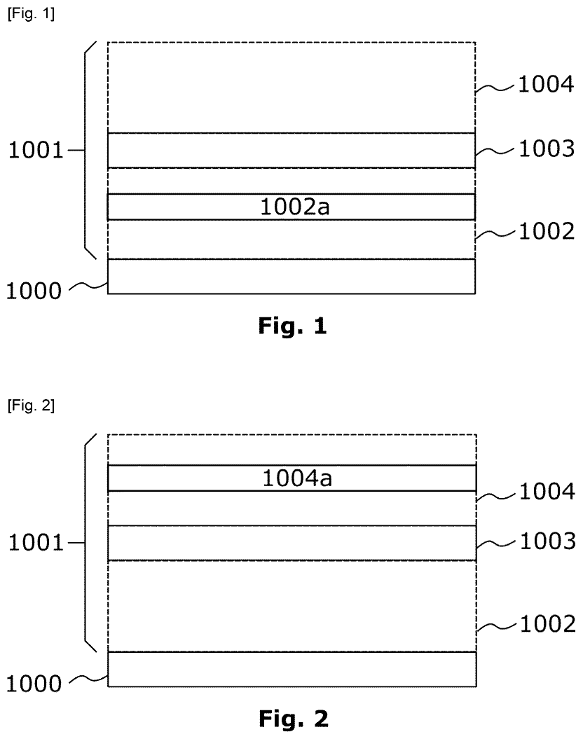

According to a first aspect of the invention, with reference to FIG. 1 and FIG. 2, a transparent substrate (1000) is provided having a functional stack (1001) of thin layers on at least one of its faces (1000a, 1000b), said functional stack (1001) comprising, starting from the substrate (1000):
at least one metallic functional layer (1003) placed between two dielectric modules (1002, 1004) of thin layers, and wherein at least one of the dielectric modules (1002, 1004) of thin layers comprises a layer (1002a, 1004a) of tungsten oxide, and the tungsten oxide comprises at least one doping element selected from the chemical elements of group 1 according to the nomenclature of the IUPAC.

Surprisingly, a layer of tungsten oxide comprising a doping element chosen by the elements of group 1 according to the nomenclature of the IUPAC has unexpected optical characteristics, in particular in terms of the evolution of the optical extinction coefficient and of the refractive index as a function of the wavelength of the electromagnetic radiation. These characteristics combined with the presence of a metal functional layer have a synergistic effect on the increase in selectivity.

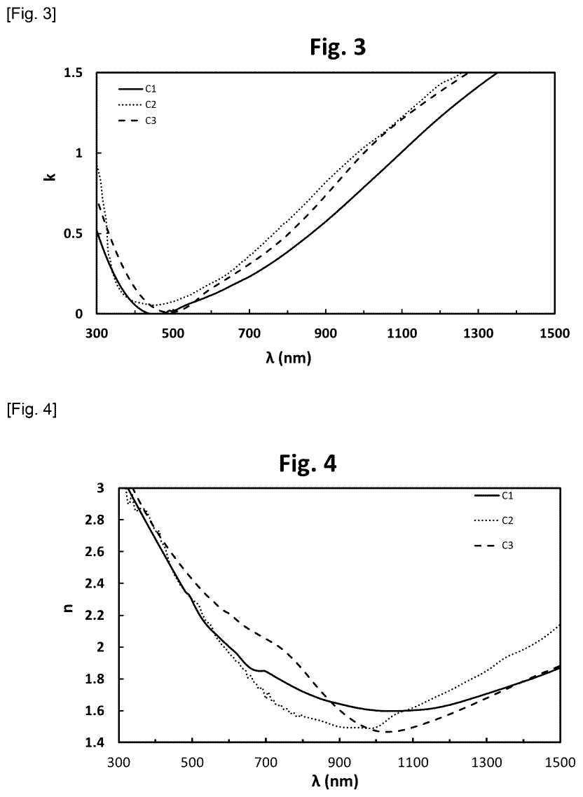

As illustrative and explanatory examples, to which however the present invention should not be considered as inextricably linked, the changes in the optical extinction coefficient, k, and in the optical refractive index, n, for a layer of cesium-doped tungsten oxide deposited by sputtering on a substrate made of soda-lime-silica glass according to three deposition conditions are shown in FIG. 3 and FIG. 4 respectively. The molar ratio of cesium to tungsten is about 0.05-0.06.

The layers C1, C2 and C3 were deposited on a substrate made of soda-lime-silica glass on which a first layer based on silicon nitride has been deposited with a thickness of approximately 5 nm. They were then covered with a second layer based on silicon nitride with a thickness of about 5 nm. In other words, each layer C1, C2 and C3 is encapsulated between two layers based on silicon nitride.

The encapsulation of the layers C1, C2 and C3 by two layers based on silicon nitride has the function of preventing the degradation of the layers C1, C2 and C3 through excessive oxidation and/or excessive diffusion of oxygen in their structure. Instead of silicon nitride, it is possible to use any other type of suitable nitride such as, for example, zirconium nitride.

The layer C1 was deposited under an atmosphere comprising 25% dioxygen at a pressure of 4 mTorr, the layer C2 under an atmosphere comprising 20% dioxygen at a pressure of 4 m Torr and the layer C3 under an atmosphere comprising 5% dioxygen at a pressure of 10 m Torr.

The stacks thus obtained comprising the layers C1, C2 and C3 were annealed at 650° C. for 10 min after deposition.

The extinction coefficient and the refractive index were calculated by modeling from experimental measurements. The measurements were obtained using a Perkin Elmer Lambda 900 spectrophotometer and a VASE M-2000XI J. A. Wollam ellipsometer.

Referring to FIG. 3, regardless of the layer C1, C2 or C3, the extinction coefficient decreases monotonically from a value less than 1 to 300 nm to reach a minimum plateau less than 0.1 between about 400 nm and 550 nm, then increases monotonically to reach a value greater than 1.2 to 1200 nm. The layers C1, C2 and C3 have a strong absorption in the near infrared and a certain transparency in the visible range of the electromagnetic spectrum.

Referring to FIG. 4, regardless of the layer C1, C2 or C3, the optical refractive index decreases monotonically from a value close to 3 at 300 nm to reach a minimum plateau less than 1.8, or even 1.6 between approximately 800 nm and 1100 nm, then increases monotonically to reach a value greater than 1.8, or even 2 at 1300-1400 nm. The changes in the optical refractive index and the optical extinction coefficient have a certain variation between the three layers C1, C2 and C3. This very moderate variability is probably due to the deposition conditions and is not detrimental to obtaining the advantages of the present invention.

According to other preferred embodiments, the optical refractive index of the tungsten oxide layer (1002a, 1004a) is decreasing monotonically with the wavelength from a maximum value greater than 2.4 at 350 nm up to a minimum value between 600 nm and 900 nm so that the difference between the maximum value and the minimum value is greater than 0.8, preferably to 1.0, or even 1.4.

In other words, the value of the optical refractive index decreases monotonically by at least 0.8, preferably at least 1.0, or even at least 1.4 between a maximum value greater than 2.4 at 350 nm and a minimum value between 600 nm and 900 nm. As an example, the optical refractive index value can decrease monotonically by at least 0.8, preferably at least 1.0, or even at least 1.4 between a maximum value greater than 2.4 at 350 nm and a minimum value less than 2.3 between 600 nm and 900 nm, especially between 800 nm and 900 nm.

Without being particularly required to obtain the effects of the present invention, these optical refractive index values may nevertheless be advantageous as regards the color specifications for applications in building and construction markets. In particular, they make it possible to obtain neutral colors.

According to certain preferred complementary embodiments, the optical extinction coefficient of the tungsten oxide layer 1002a, 1004a may be less than 0.2, or even 0.1 at 500 nm and less than 2, or even 1.5 at 1200 nm. The selectivity can thus be advantageously further increased.

The optical extinction coefficient and the optical diffraction index can vary depending on the nature and the amount of the doping element(s) selected from the elements of the group 1 according to the IUPAC nomenclature. They may in particular have different behaviors of what has been described above in the context of the illustrative and explanatory examples of FIG. 3 and FIG. 4. However, it is currently difficult to establish a law of general behavior of the optical extinction coefficient and of the refractive index according to the nature and/or the quantity of the doping element(s).

According to certain particular embodiments, the tungsten oxide layer 1002a, 1004a comprises the doping element X or the doping elements X1, X2, . . . in proportions such that the molar ratio, X/W of said element on tungsten, W, or the sum of the molar ratios of each element on tungsten (X1+X2+ . . . )/W is between 0.01 and 0.4, preferably between 0.01 and 0.2, or even between 0.01 and 0.1. It was observed that these molar ratio values can advantageously make it possible to obtain the values of optical extinction coefficient and of refractive index described in the preceding embodiments while limiting the quantity of doping elements. Furthermore, a saving on the exploitation of the mineral resources for the doping elements may possibly result, as well as a reduction in costs.

According to certain embodiments, the tungsten oxide layer 1002a, 1004a comprises at least one doping element selected from hydrogen, lithium, sodium, potassium and cesium. Among the elements of group 1, these particular elements can make it possible to obtain the most optimal values of optical extinction coefficient and refractive index for the desired technical effects.

According to particularly preferred embodiments, the tungsten oxide layer 1002a, 1004a comprises cesium as a doping element, and the molar ratio of cesium to tungsten is between 0.01 and 0.2, preferably between 0.01 and 0.1. These embodiments make it possible to obtain the best performance as to the increase in selectivity, the preservation of neutral colors, and the cost savings.

The transparent substrate 1000 may preferably be planar and may be of organic or inorganic, rigid or flexible nature. In particular, it may be a mineral glass, for example a soda-lime-silica glass.

Examples of organic substrates which can advantageously be used in the implementation of the invention may be polymer materials, such as polyethylenes, polyesters, polyacrylates, polycarbonates, polyurethanes or polyamides. These polymers can be fluoropolymers.

Examples of inorganic substrates which can advantageously be employed in the invention may be sheets of inorganic glass or glass-ceramic. The glass may preferably be a glass of soda-lime-silica, borosilicate, aluminosilicate or else alumino-borosilicate type. According to a preferred embodiment of the invention, the transparent substrate 1000 is a sheet of soda-lime-silica mineral glass.

Referring to FIG. 1, according to advantageous embodiments, the tungsten oxide layer 1002a can be comprised in the dielectric module 1002 of layers located under the metal functional layer 1003, between said substrate 1000 and said functional metal layer 1003. The presence of the layer of tungsten oxide 1002a in the dielectric module 1002 of layers located under the metal functional layer 1003 makes it possible both to reduce the solar factor value and/or to increase the light transmission.

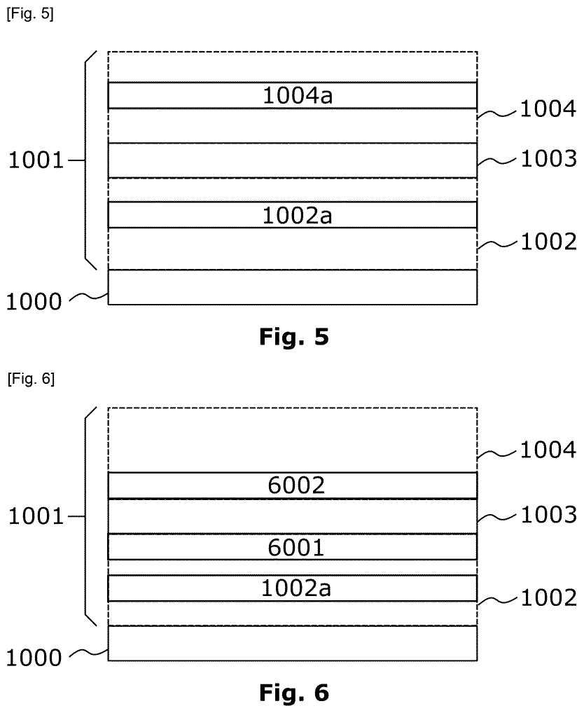

Referring to FIG. 5, according to preferred embodiments, each dielectric module 1002,1004 of layers comprises a tungsten oxide layer 1002a, 1004a. The presence of the layer of tungsten oxide 1002a, 1004a in each dielectric module 1002, 1004 allows the greater reductions in the solar factor and the most important increases in the light transmission.

According to certain advantageous embodiments, the physical thickness of the tungsten oxide layer(s) 1002a, 1004a can be between 2 nm and 50 nm, in particular between 5 nm and 30 nm, preferably between 5 nm and 20 nm. These intervals of thicknesses are sufficient to obtain the remarkable advantages of the first aspect of the invention.

According to embodiments, with reference to FIG. 6, the functional stack 1001 of layers further comprises a blocking metal overlayer 6002, preferably based on nickel and chromium alloy, located above and in contact with the functional metal layer 1003 and/or a blocking metal underlayer 6001, preferably based on nickel and chromium alloy, located below and in contact with the functional metal layer 1003.

The presence of a blocking metal overlayer 6002 and/or of a blocking metal underlayer 6001 makes it possible to advantageously increase the durability of the stack, for example in terms of mechanical resistance to brushing or scratching. It also makes it possible to avoid deterioration, for example oxidation, of the metal functional layer 1003 during the deposition of the subsequent layers and/or during heat treatments, in particular by limiting the diffusion of certain chemical elements from the adjacent layers and/or the diffusion of oxygen.

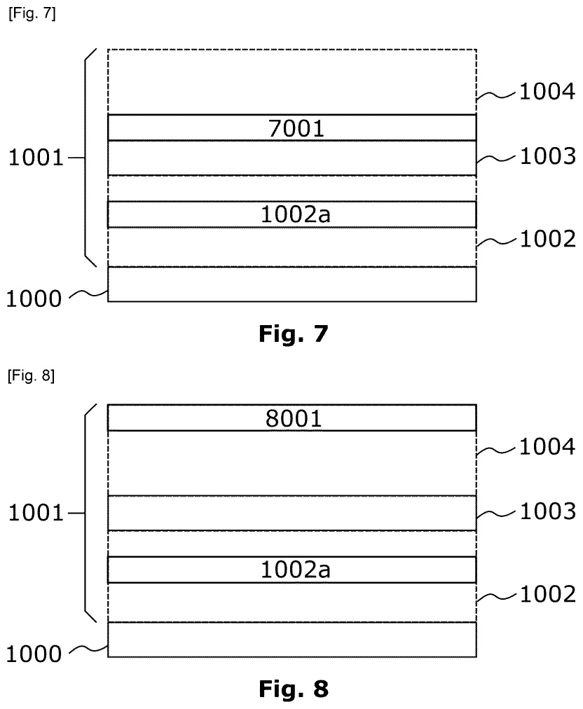

According to other embodiments, with reference to FIG. 7, the functional stack 1001 of thin layers can further comprise a titanium oxide overlayer 7001 located above, preferably in contact with, the metal functional layer 1003, said overlayer 4000 preferably having a physical thickness of at least 5 nm. The titanium oxide overlayer 7001 increases the selectivity.

According to particular embodiments, with reference to FIG. 8, the functional stack 1001 of layers comprises a layer 8001 of refractive index less than 2.45 at 550 nm, said layer being comprised within the dielectric module 1004 of layers forming the upper part of the functional stack 1001 starting from the substrate 1000. Preferably, said layer 8001 is the last layer of the dielectric module 1004.

The combination of a layer with a refractive index less than 2.45 at 550 nm in the last dielectric module 1004 with a tungsten oxide layer 1002a, 1004a in the first and/or second dielectric modules 1002, 1004 makes it possible to prevent any structural degradation of the layer(s) 1002a, 1004a, of tungsten oxide by the optional diffusion of elements, such as oxygen, from the adjacent layers.

According to other particular embodiments, the functional stack 1001 of layers comprises a layer with a refractive index less than 2.45 at 550 nm, said layer being comprised within the dielectric module 1002 of layers forming the lower part of the functional stack 1001 starting from the substrate 1000.

According to preferred embodiments, the functional stack 1001 of layers comprises a first layer with a refractive index less than 2.45 at 550 nm, said first layer being comprised within the dielectric module 1002 of layers forming the lower part of the functional stack 1001 starting from the substrate 1000, and a second layer having a refractive index less than 2.45 at 550 nm, said second layer being comprised in the dielectric module 1004 of layers forming the upper part of the functional stack 1001 starting from the substrate 1000.

The layer or layers with a refractive index less than 2.45 at 550 nm are preferably based on oxide or nitride of silicon, zirconium, titanium, or tin and zinc. As examples, they may be based on silicon nitride, silicon oxide, zirconium nitride or zinc and tin oxide.

The function of the functional metal layer 1003 is to reflect infrared radiation and/or part of the solar radiation. It may be any suitable metal, for example based on gold or based on silver. The thickness of the functional metal layer 1003 may typically be between 2 nm and 25 nm, preferably between 10 nm and 20 nm.

According to preferred embodiments, the functional metal layer 1003 is silver-based.

The dielectric modules may comprise one or more layers with oxides and/or nitrides of metal and/or metal alloys, such as, for example, zinc oxide, mixed zinc tin oxide, silicon nitride, silicon oxide, zirconium nitride, titanium oxide, tin oxide, and silicon oxy-nitride.

The methods for depositing thin layers on substrates, in particular glass substrates, are methods well known in industry. By way of example, the deposition of a stack of thin layers on a glass substrate is carried out by successive depositions of each thin layer of said stack by passing the glass substrate through a succession of deposition cells suitable for depositing a given thin layer.

The deposition cells can use deposition methods such as magnetic field assisted sputtering, ion beam assisted deposition (IBAD), evaporation, chemical vapor deposition (CVD), plasma enhanced chemical vapor deposition (PECVD), low pressure chemical vapor deposition (LPCVD), etc.

The magnetic field enhanced sputtering deposition method is particularly used. The conditions for deposition of layers are widely documented in the literature, for example in patent applications WO2012/093238 A1 and WO2017/00602 A1.

A second aspect of the invention relates to a glazing, in particular single, double or triple glazing, comprising a transparent substrate according to any one of any of the described embodiments.

A monolithic glazing comprises a single substrate, in particular a mineral glass sheet. It may be a single glazing. When the substrate according to the invention is used as monolithic glazing, the functional stack of this layers is preferably deposited on the face of the substrate directed toward the interior of the room of the building on the walls of which the glazing is installed. In such a configuration, it can be advantageous to protect the first layer and optionally the stack of thin layers from physical or chemical damage using an appropriate means.

A multiple glazing comprises at least two substrates, in particular mineral glass sheets, that are parallel and separated by an insulating gas-filled cavity. The majority of multiple glazings are double or triple glazings, that is to say that they respectively comprise two or three glazings. When the substrate according to the invention is used as element of a multiple glazing, the functional stack of thin layers is preferably deposited on the face of the glass sheet directed inward in contact with the insulating gas. This arrangement has the advantage of protecting the stack from chemical or physical damage from the external environment.

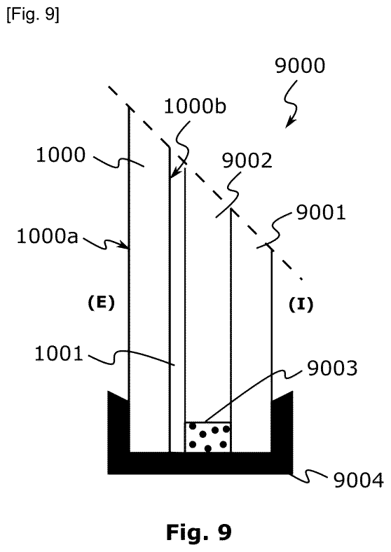

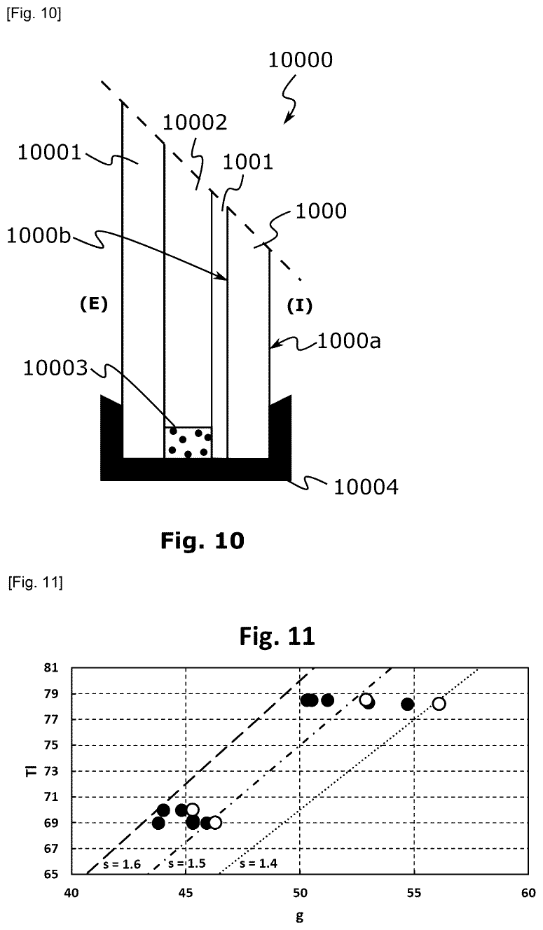

According to preferred embodiments, with reference to FIG. 9 and FIG. 10, the glazing is a double glazing 9000, 10000 comprising a transparent substrate 1000 according to one according to any of the above-described embodiments arranged so that the functional stack 1001 of layers is located facing two and/or three of said glazing 9000, 10000. In the figure, (E) corresponds to the exterior of the premises where the glazing is installed, and (I) to the interior of the premises.

According to a first embodiment, with reference to FIG. 9, the glazing 9000 comprises a first transparent glass sheet 1000 with an inner surface 1000a and an outer surface 1000b, a second glass sheet 9001 with an inner surface 9001a and an outer surface 9001b, an insulating gas-filled cavity 9002, a spacer 9003 and a seal 9004.

The glass sheet 1000 comprises, on and in contact with its inner surface 1000b in contact with the gas of the insulating gas-filled cavity 9002, a functional stack 1001 according to the first aspect of the invention. The functional assembly 1001 is preferably deposited so that its outer surface, which is opposite the surface 1000b of the transparent glass sheet 1000, is directed toward the interior (I) of the premises, for example a building, in which the glazing is used. In other words, the functional stack 1001 is arranged on face 2 of the glazing starting from the exterior (E).

According to another embodiment, with reference to FIG. 10, the glazing is a double glazing 10000 comprising a first glass sheet 1000 with an inner surface 1000a and an outer surface 1001b, a second transparent glass sheet 10001 with an inner surface 1001a and an outer surface 1001b, an insulating gas-filled cavity 10004, a spacer 10003 and a seal 10004.

The glass sheet 1000 comprises, on its inner surface 1000a in contact with the gas of the insulating gas-filled cavity 9004, a functional stack 1001 according to the first aspect of the invention. The functional assembly 1001 is preferably arranged so that its outer surface that is opposite the surface 1000a of the transparent glass sheet 1000 is directed toward the exterior (E) of the premises. In other words, the functional stack (1001) is arranged on face 3 of the glazing starting from the exterior (E).

According to a third aspect of the invention, a method is provided for manufacturing a transparent substrate according to the first aspect of the invention, such that the tungsten oxide layer is deposited by a magnetron sputtering method using a tungsten oxide target doped using a chemical element chosen from the chemical elements of group 1 according to the IUPAC nomenclature.

The tungsten oxide target may in particular contain one or more doping elements in the proportions as described for the tungsten oxide layer doped in some embodiments of the first aspect of the invention.

The tungsten layer or layers can be deposited by sputtering using the aforementioned target under an atmosphere comprising 0% to 50%, preferably 5% to 25% dioxygen under a pressure comprised between 1 and 15 mTorr, preferably 3 to 10 mTorr. Preferably, the deposition can be carried out cold, that is to say at a temperature of less than 100° C., in particular between 20° C. and 60° C., for the substrate.

All the embodiments described, whether they relate to the first aspect or the second aspect of the invention, can be combined with one another without modification or particular adaptation. In the event that technical incompatibilities appear during the implementation of one of these combinations, it is within the scope of the person skilled in the art to be able to solve them by means of their knowledge without this requiring undue effort, in particular by implementing a research program.

### EXAMPLES

The features and advantages of the invention are shown by the examples and counter-examples described hereinafter.

Seventeen examples, E1-E17, in accordance with the invention are described in Tables 1, 2 and 3 which indicate the composition and the thickness expressed in nanometers of the various layers. The numbers in the first two columns correspond to the references of the figures.

The layer, denoted CWO, of cesium-doped tungsten oxide. The molar ratio of cesium to tungsten is about 0.05-0.06.

TABLE 1

| | | | E1 | E2 | E3 | E4 | E5 | E6 |
|---|---|---|---|---|---|---|---|---|
| | | TiOx | 1.5 | 1.5 | 1.5 | 1.5 | 1.5 | 1.5 |
| 1004 | | SiN | 41 | 42 | 41 | 17 | 41 | 24 |
| | | SnZnO | | | | 5 | | |
| | | SiZr | | | | | | |
| | 1004a | CWO | | | | | | 19 |
| | 7001 | TiOx | | | | 20 | | |
| | | ZnO | 5 | 5 | 5 | | 5 | 5 |
| | 6002 | NiCrOx | 0.6 | 0.6 | 0.6 | 0.6 | 0.6 | 0.6 |
| 1003 | | Ag | 16.6 | 16.6 | 17.0 | 17.5 | 16.6 | 16.3 |
| 1002 | | ZnO | 5 | 5 | 5 | 5 | 5 | 5 |
| | 1002a | CWO | 17 | 10 | 10 | 19 | 17 | 18 |
| | | SiZr | | | | | | |
| | | SiN | 9 | 17 | 12 | 5 | 9 | 5 |
| 1000 | | glass | 4 mm | 4 mm | 4 mm | 4 mm | 4 mm | 4 mm |

TABLE 2

| | | | E7 | E8 | E9 | E10 | E11 | E12 |
|---|---|---|---|---|---|---|---|---|
| | | TiOx | 1.5 | 1.5 | 1.5 | 1.5 | 1.5 | 1.5 |
| 1004 | | SiN | 41 | 30 | 17 | 13 | 24 | 35 |
| | | SnZnO | | | 5 | 10 | 6 | |
| | | SiZr | | | | | | |
| | 1004a | CWO | | 11 | | | | |
| | 7001 | TiOx | | | 20 | 20 | 14 | |
| | | ZnO | 5 | 5 | | | | 5 |
| | 6002 | NiCrOx | 0.6 | 0.6 | | | | 0.6 |
| 1003 | | Ag | 17.0 | 17.4 | 17.5 | 18.3 | 18.5 | 12.9 |
| 1002 | | ZnO | 5 | 5 | 5 | 5 | 5 | 5 |
| | 1002a | CWO | 10 | 15 | 19 | 19 | 16 | 15 |
| | | SiZr | | | | | | |
| | | SiN | 12 | 5 | 5 | 5 | 5 | 22 |
| 1000 | | glass | 4 mm | 4 mm | 4 mm | 4 mm | 4 mm | 4 mm |

TABLE 3

| | | | E13 | E14 | E15 | E16 | E17 |
|---|---|---|---|---|---|---|---|
| | | TiOx | 1.5 | 1.5 | 1.5 | 1.5 | 1.5 |
| 1004 | | SiN | 18 | 21 | 5 | 5 | 19 |
| | | SnZnO | | | 10 | 5 | 5 |
| | | SiZr | | | | | |
| | 1004a | CWO | 20 | 15 | | | 12 |
| | 7001 | TiOx | | | 20 | 25 | 5 |
| | | ZnO | 5 | 5 | | | |
| | 6002 | NiCrOx | 0.6 | 0.6 | | | |
| 1003 | | Ag | 12.6 | 14.2 | 13.2 | 14.8 | 14.8 |
| 1002 | | ZnO | 5 | 5 | 5 | 5 | 5 |
| | 1002a | CWO | 23 | 20 | 18 | 24 | 20 |
| | | SiZr | | | | | |
| | | SiN | 5 | 5 | 19 | 5 | 5 |
| 1000 | | glass | 4 mm | 4 mm | 4 mm | 4 mm | 4 mm |

Examples E1 to E5, E7, E9 to E12, E15 and E16 comprise only one doped tungsten oxide layer 1002a in the first dielectric module 1002. Examples E6, E8, E13 to E14 and E17 comprise two doped tungsten oxide layers 1002a, 1004a located in the first 1002 and second 1004 dielectric modules. The corresponding counter-examples are counter-examples CE1 and CE3.

Examples E9 to E11 and examples E15 to E17 are examples in accordance with certain advantageous embodiments wherein a titanium oxide-based layer 7001 is located above and in contact with the metal functional layer 1003. The corresponding counter-examples are the counter-examples CE2 and CE4.

Four counter-examples, CE1-CE4 are described in Table 4 which indicates the composition and thickness expressed in nanometers of the various layers.

TABLE 3

| | | | CE1 | CE2 | CE3 | CE4 |
|---|---|---|---|---|---|---|
| | | TiOx | 1.5 | 1.5 | 1.5 | 1.5 |
| 1004 | | SiN | 40 | 30 | 37 | 25 |
| | | SnZnO | | | | |
| | | SiZr | | | | |
| | 1004a | CWO | | | | |
| | 7001 | TiOx | | 5 | | 10 |
| | | ZnO | 5 | | 5 | |
| | 6002 | NiCrOx | 0.6 | | 0.6 | |
| 1003 | | Ag | 17.0 | 18.5 | 13.4 | 15.7 |
| 1002 | | ZnO | 5 | 5 | 5 | 5 |
| | 1002a | CWO | | | | |
| | | SiZr | | 14 | | 23 |
| | | SiN | 22 | 5 | 28 | 0 |
| 1000 | | glass | | | | |

The stacks of thin layers of the seventeen examples E1-E17 and of counter-examples CE1-CE4 were deposited by magnetic-field-assisted cathode sputtering (magnetron method) whose characteristics are widely documented in the literature, for example in patent applications WO2012/093238 and WO2017/00602. The substrate 1000 is a soda-lime-silica mineral glass 4 mm thick. After deposition, the substrates were subjected to a heat treatment at 650° C. for 10 min.

The nature of the targets used and the deposition conditions of examples E1 to E17 and counter-examples CE1-CE4 are grouped in table 5.

TABLE 5

| | | Pressure | Ar | O2 | N2 | Power |
|---|---|---|---|---|---|---|
| | Target | (μbar) | (sccm) | (sccm) | (sccm) | (W) |
| TiOx | TiOx | 2 | 10 | 2 | 0 | 2000 |
| SnZnO | Sn60Zn40 | 2 | 7 | 44 | 0 | 1000 |
| SiN | SiN | 5 | 7 | 0 | 14 | 2000 |
| SiZr | Si:ZR 27 | 2 | 15 | 0 | 15 | 1000 |
| | wt. % | | | | | |
| NiCrOx | NiCr | 2 | 20 | 0 | 0 | 70 |
| Ag | Ag | 8 | 40 | 0 | 0 | 210 |
| ZnO | ZnO:Al 2 | 2 | 40 | 2 | 0 | 1300 |
| | wt. % | | | | | |
| CWO | CWO | 4-10 | 30-40 | 2-10 | 0 | 1300 |

The solar factor, g, the selectivity, s, the light transmission, TL, the light reflection on the interior face, Rint, and on the exterior face, Rext, as well as the color in transmission, on the interior face and on the exterior face, were measured for each substrate of examples E1 to E17 and of counter-examples CE1 to CE4 assembled in a double glazing, as shown in FIG. 9. The second glass sheet 9001 is a soda-lime-silica mineral glass with a thickness of 4 mm. The thickness of the air gap 9002 is 16 mm. The stack is arranged on face 2, or on the face 1001b of the substrate 1000.

The expression “color”, used to describe a transparent substrate provided with a stack, is understood to mean the color as defined in the L*a*b* CIE 1976 chromatic space according to standard ISO 11664, in particular with a D65 illuminant and a visual field of 2° or 10° for the reference observer. It is measured in accordance with said standard.

The light transmission in the visible spectrum, TL, the solar factor, g, and the selectivity, s, and the internal reflection, Rint, and the external reflection, Rext, in the visible spectrum are defined, measured and calculated in conformity with the standards EN 410, ISO 9050 and/or ISO 10292.

The solar factor, selectivity, light transmission, internal reflection and external reflection measurements are grouped in Table 6. The measurements of the color parameters a* and b*, in transmission (a*T, b*T), in external reflection (a*Rext, b*Rext) and in internal reflection (a*Rint, b*Rint) are grouped in table 7.

TABLE 6

| | g | s | TL | Rint | Rext |
|---|---|---|---|---|---|
| E1 | 45.3 | 1.523 | 69.0 | 20.8 | 20.0 |
| E2 | 45.9 | 1.503 | 69.0 | 21.0 | 20.0 |
| E3 | 45.3 | 1.528 | 69.2 | 22.6 | 20.8 |
| E4 | 43.8 | 1.575 | 69.0 | 20.7 | 19.1 |
| E5 | 45.3 | 1.523 | 69.0 | 20.8 | 20.0 |
| E6 | 44.8 | 1.564 | 70.0 | 23.7 | 21.7 |
| E7 | 45.3 | 1.528 | 69.2 | 22.6 | 20.8 |
| E8 | 44.0 | 1.593 | 70.0 | 23.4 | 21.3 |
| E9 | 43.8 | 1.575 | 69.0 | 20.7 | 19.1 |
| E10 | 44.0 | 1.593 | 70.0 | 23.2 | 20.8 |
| E11 | 44.0 | 1.592 | 70.0 | 23.2 | 20.9 |
| E12 | 54.7 | 1.428 | 78.2 | 12.1 | 12.4 |
| E13 | 52.9 | 1.485 | 78.5 | 15.0 | 14.0 |
| E14 | 50.5 | 1.554 | 78.5 | 14.6 | 13.7 |
| E15 | 53.0 | 1.478 | 78.3 | 11.5 | 11.8 |
| E16 | 51.2 | 1.534 | 78.5 | 14.5 | 13.5 |
| E17 | 50.3 | 1.561 | 78.5 | 14.7 | 13.7 |
| CE1 | 46.3 | 1.489 | 69.0 | 24.1 | 21.9 |
| CE2 | 45.3 | 1.544 | 70.0 | 22.9 | 21.0 |
| CE3 | 56.1 | 1.394 | 78.2 | 14.9 | 13.9 |
| CE4 | 52.9 | 1.485 | 78.5 | 14.2 | 13.4 |

TABLE 7

| | a*T | b*T | a*Rext | b*Rext | a*Rint | b*Rint |
|---|---|---|---|---|---|---|
| E1 | −4.0 | −1.0 | 2.3 | −3.4 | 4.1 | −4.1 |
| E2 | −4.1 | 1.3 | 2.3 | −3.7 | 4.5 | −5.9 |
| E3 | −4.6 | 1.4 | 1.0 | −3.5 | 3.4 | −4.9 |
| E4 | −4.1 | 0.6 | 1.7 | −6.8 | 3.8 | −7.2 |
| E5 | −4.0 | −1.0 | 2.3 | −3.4 | 4.1 | −4.1 |
| E6 | −3.9 | 3.0 | 3.0 | −5.1 | 4.6 | −7.1 |
| E7 | −4.6 | 1.4 | 1.0 | −3.5 | 3.4 | −4.9 |
| E8 | −4.1 | 3.0 | 2.2 | −2.8 | 4.0 | −5.0 |
| E9 | −4.1 | 0.6 | 1.7 | −6.8 | 3.8 | −7.2 |
| E10 | −4.0 | 3.0 | 2.9 | −4.5 | 4.4 | −6.1 |
| E11 | −4.0 | 3.0 | 2.0 | −2.6 | 4.0 | −5.2 |
| E12 | −3.5 | −1.0 | 3.0 | −4.7 | 4.9 | −2.9 |
| E13 | −3.2 | 2.4 | 3.0 | −7.2 | 4.4 | −8.0 |
| E14 | −3.8 | 3.0 | 2.5 | −4.8 | 4.3 | −6.1 |
| E15 | −4.0 | 0.5 | 1.8 | −8.0 | 4.7 | −6.1 |
| E16 | −3.5 | 3.0 | 3.0 | −7.2 | 4.3 | −8.0 |
| E17 | −3.8 | 3.0 | 2.3 | −4.5 | 4.1 | −5.9 |
| CE1 | −3.6 | 4 | 3.2 | −7.7 | 4.3 | −8.1 |
| CE2 | −4.3 | 3.4 | 3.0 | −3.8 | 4.7 | −5.4 |
| CE3 | −2.9 | 2.7 | 3.1 | −8.8 | 4.0 | −8.0 |
| CE4 | −3.8 | 3.0 | 3.0 | −4.8 | 4.8 | −5.7 |

The light transmission, TL and solar factor, g values are shown in FIG. 11 for examples E1 to E17 (solid circles) and counter-examples CE1 to CE 4 (empty circles). This graph also shows the selectivity thresholds, s=1.4; s=1.5 and s=1.6 as guides for the eyes.

FIG. 11 shows that high selectivity values are obtained both with the examples E1 to E5, E7, E9 to E12, E15 and E16 comprising only one doped tungsten oxide layer 1002a in the first dielectric module 1002, with examples E6, E8, E13 to E14 and E17 comprising two doped tungsten oxide layers 1002a, 1004a located in the first 1002 and second 1004 dielectric modules.

As shown in FIG. 11, examples E1 to E17 and counter-examples CE1 to CE7 can be divided into two groups. The group of examples E1 to E11 and counter-examples CE1 and CE2 for which the light transmission is about 70% and the group of examples E12 to E17 and counter-examples CE3 and CE4 for which the light transmission is greater than 78%.

For the first group, that is, the examples and counter-examples having a light transmission of about 70%, FIG. 11 clearly shows a reduction of the solar factor for the examples according to the invention in comparison with counter-examples CE1 and CE2. In particular, the selectivity of the examples is greater than 1.50 or even 1.55.

The counter-example CE2 has a selectivity greater than 1.50 but less than 1.55. This counter-example CE2 comprises a layer of titanium oxide arranged above and in contact with the metallic functional layer. The corresponding examples E9 to E11 have a lower solar factor value and therefore a higher selectivity.

For the second group, that is, the examples and counter-examples having a light transmission greater than 78%, FIG. 11 clearly shows a reduction of the solar factor for the examples according to the invention in comparison with counter-examples CE3 and CE4. In particular, the selectivity of the examples is greater than 1.40 or even 1.50.

The counter-example CE4 has a selectivity greater than 1.40 but less than 1.50. This counter-example CE4 comprises a layer of titanium oxide arranged above and in contact with the metallic functional layer. The corresponding examples E15 to E17 have a lower solar factor value and therefore a higher selectivity.

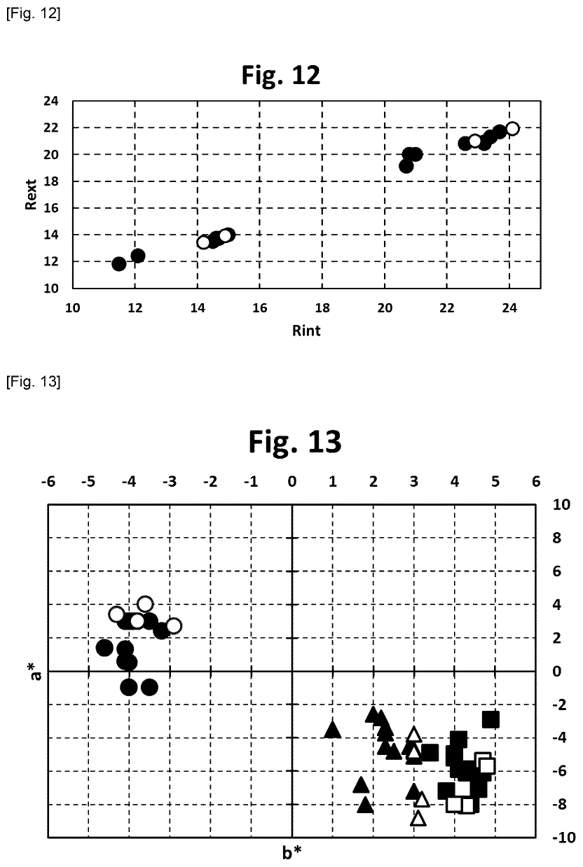

The light reflection values on the interior face, Rint, and on the exterior face, Rext, are shown in FIG. 12 for examples E1 to E17 (solid circles) and counter-examples CE1 to CE 4 (empty circles).

FIG. 12 shows that the examples according to the invention have reflection levels on the internal face and on the external face less than, or otherwise equivalent, to those of the counter-examples for comparable light transmission values. In other words, the invention also makes it possible to reduce light reflection while preserving the same level of light transmission.

The values of the color parameters a*, b* are shown in FIG. 13 for examples E1 to E17 (shown solid) and counter-examples CE1 to CE 4 (shown empty). The color parameters in transmission a*T, b*T are represented by circles, the parameters in reflection on the exterior face a*Rext, b*Rext are represented by triangles, and the parameters in reflection on the interior face a*Rint, b*Rint are represented by squares.

In transmission, the examples according to the invention, in particular most examples which comprise only a doped tungsten oxide layer 1002 in the first dielectric module 1002, have a lower color parameter b*. The counter-examples have a color that is shifted toward yellow.

In the external face reflection, the examples according to the invention have a lower color parameter a*Rext. The examples which comprise only one doped tungsten oxide layer 1002 in the first dielectric module 1002 also have a higher color b*Rext parameter, that is to say approaching zero. The counter-examples have a color shifted towards the red.

In internal face reflection, the examples according to the invention have a lower color parameter a*Rint and a higher color parameter b*Rext. The counter-examples have a color shifted toward the violet.

These examples very clearly show the advantages of the substrates of the invention, namely that they have a reduced solar factor, a higher selectivity, and a more neutral color.

1. A transparent substrate provided with a functional stack of thin layers on at least one of its faces, said functional stack comprising, starting from the substrate:
at least one metallic functional layer placed between two dielectric modules of thin layers, and wherein at least one of the two dielectric modules of thin layers comprises a layer of tungsten oxide, and
the tungsten oxide comprises at least one doping element selected from the chemical elements of group 1 according to the IUPAC nomenclature.

2. The substrate according to claim 1, wherein the optical refractive index of the tungsten oxide layer is decreasing monotonically with a wavelength from a maximum value greater than 2.4 at 350 nm up to a minimum value between 600 nm and 900 nm so that a difference between the maximum value and the minimum value is greater than 0.8.

3. The substrate according to claim 1, wherein an optical extinction coefficient of the tungsten oxide layer is less than 0.2 at 500 nm and less than 2 at 1200 nm.

4. The substrate according to claim 1, wherein the tungsten oxide layer comprises the doping element or several doping elements in proportions such that a molar ratio of said element to tungsten or a sum of the molar ratios of each element to tungsten is between 0.01 and 0.4.

5. The substrate according to claim 1, wherein the tungsten oxide layer comprises at least one doping element selected from hydrogen, lithium, sodium, potassium and cesium.

6. The substrate according to claim 2, wherein the tungsten oxide layer comprises cesium as a doping element, and a molar ratio of cesium to tungsten is between 0.01 and 0.2.

7. The substrate according to claim 1, wherein the tungsten oxide layer is comprised in the dielectric module of layers located under the metallic functional layer, between said substrate and said metallic functional layer.

8. The substrate according to claim 1, wherein each dielectric module of layers comprises a layer of tungsten oxide.

9. The substrate according to claim 1, wherein a physical thickness of the tungsten oxide layer is between 2 nm and 50 nm.

10. The substrate according to claim 1, wherein the functional stack of layers further comprises a blocking metal overlayer located above and in contact with the metallic functional layer and/or a metallic blocking underlayer located below and in contact with the metallic functional layer.

11. The substrate according to claim 1, wherein the functional stack of layers further comprises an overlayer of titanium oxide located above the metallic functional layer.

12. The substrate according to claim 1, wherein the functional stack of layers comprises a layer with a refractive index less than 2.45 at 550 nm, said layer being comprised in the dielectric module of layers forming the upper part of the functional stack starting from the substrate.

13. The substrate according to claim 1, wherein the metallic functional layer is a silver-based layer.

14. A glazing comprising at least two transparent substrates, one of the substrates being a substrate according to claim 1 arranged such that the functional stack of layers is located facing two and/or facing three of said glazing.

15. A method for manufacturing a transparent substrate according to claim 1, comprising depositing the tungsten oxide layer by a magnetron sputtering method using a tungsten oxide target doped using a chemical element chosen from the chemical elements of group 1 according to the IUPAC nomenclature.

16. The substrate according to claim 2, wherein the difference between the maximum value and the minimum value is greater than 1.4.

17. The substrate according to claim 4, wherein the molar ratio of said element to tungsten or the sum of the molar ratios of each element to tungsten is between 0.01 and 0.1.

18. The substrate according to claim 6, wherein the tungsten oxide layer comprises cesium as a doping element, and the molar ratio of cesium to tungsten is between 0.01 and 0.1.

19. The substrate according to claim 9, wherein the physical thickness of the tungsten oxide layer is between 5 nm and 20 nm.

20. The substrate according to claim 10, wherein the blocking metal overlayer is based on nickel and chromium alloy and/or the metallic blocking underlayer is based on nickel and chromium alloy.
